(19) United States
(12) Patent Application Publication
(10) Pub. No.: US 2005/0126502 A1
(43) Pub. Date: Jun. 16, 2005

(54) Multiple cat, and puppy feeder

(76) Inventor: George Richard Leary, Bearsville, NY (US)

Correspondence Address: George Richard Leary, P.O. Box 123, Bearsville, NY, 12409, US

(21) Appl. No.: 11/004,272

(22) Filed: Dec. 3, 2004

Related U.S. Application Data
(60) Provisional application No. 60/528,250, filed on Dec. 10, 2003.

(51) Int. Cl. A01K 5/01

(52) U.S. Cl. 119/61.56

(57) ABSTRACT

The T shaped handle is five inches across and eight and a half inches long and two and a half inches in thickness. The T shaped handle screws down through the mount attached to the lower plate. The plate is ten inches long and four and a half inches wide, The T shaped handle goes into the mount which is two inches high. This mount is attached to the plate. The handle screws in to the mount through the center of the feeding apparatus. One inch long horizontal and one and a half inner height bowl connection to side walls which are five and a half inches high. Each stall is four inches wide and five inches deep. The bowls are connected to the side walls making it one piece. This feeder has partitioned side walls with a one inch extention that creates more depth and isolation to each stall for separate feedings. The Multi-Feeder has a raised enter wall with portal handles.

The Multiple Cat and Puppy Feeder is designed so that each group of pets has its own individual feeding compartment. The walls are designed to direct the pets attention to the feeding bin. This is a training exerise for later use for the direction of later individual feeding as during weaning. The Multiple Cat and Puppy Feeder comes in four sizes. Four, eight, twelve, and sixteen, also by special order. One can feed at least twelve-small pets at one time. The Multiple Cat and Puppy Feeder has a special designed scooped bottom for easy cleaning.

First you fill the bottom of the feeding tray with food. You lead your pet or pets to their places and let them eat. It will not be long before they can find their places and feed themselves without a problem. Place the food wet or dry in the compartments you wish to feed them from. This set comes with a thirteen inch T handle for carrying or placing the Multi-Feeder. The handle screws into the middle of the Feeder for easier handling.

### THE MULTIPLE CAT AND PUPPY FEEDER BACKGROUND

We were surprised with eighteen puppies and a measure of cats at the same time. When they were old enough we would put down pans of food at feeding time. This was hilarious to watch, there must be a better way so we came up with the Multiple Cat and Puppy Feeder.

In summary the object is to feed your pet puppies and cats. The second object is to do this comfortably. You use the T shape or ball shape handle to manuever the stalls for the best placement for feeding. Right in the bottom of the stalls are the rounded bins. You measure the food wet or dry and feed them. When they are finished eating take a sponge dipped in soapy water and wipe out the round bottom bowl shaped bins then rinse with clear water and the feeder can be used again.

### ILLUSTRATIONS OF THE MULTIPLE CAT AND PUPPY FEEDER

Page 1 FIG. 1 cross section of the whole stall

Page 1 FIG. 2 is the round bottom molded bowl in place as one piece.

Page 1 FIG. 2 number 9 is the inner wall and back of stall.

Page 1 FIG. 10 the bowl and side wall.

Page 1 FIG. 2 view of the feeding bin.

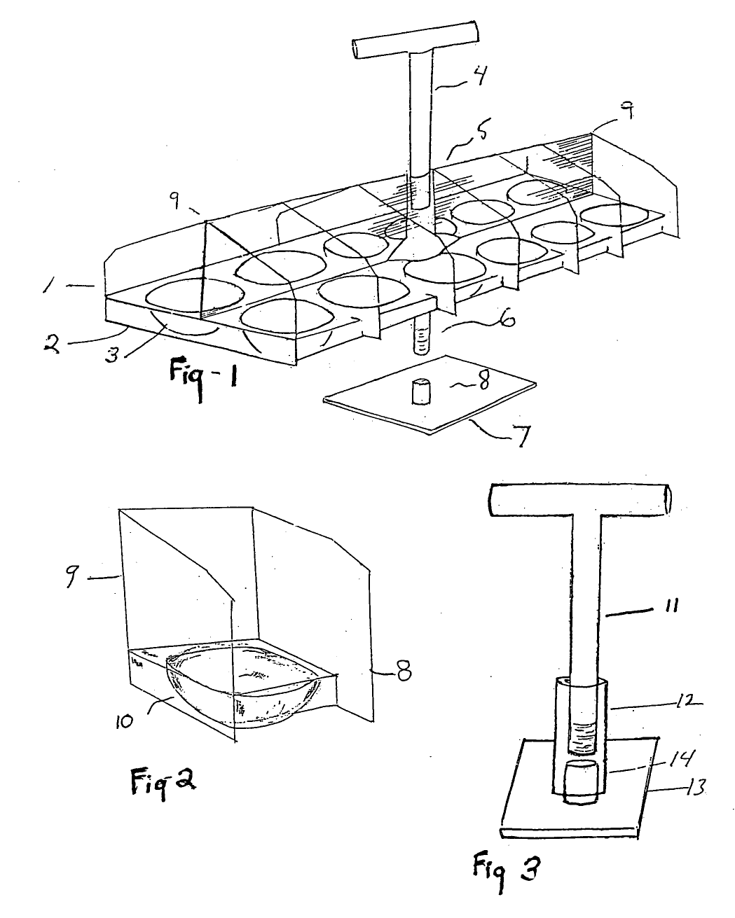

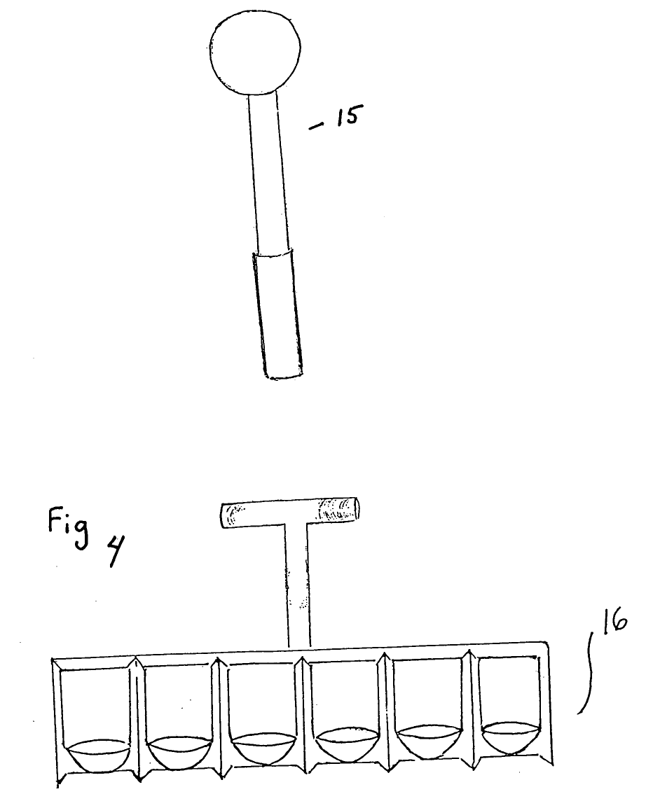

Page 1 FIG. 3 number 11 T handle

page 1 FIG. 3 number 12 is the molded brace that holds the T handle in the center of the stall that is molded as one whole piece to the rest of the stall.

Page 1 number 13 is the bottom plate that holds the flair which the T handle screws into the above number 14.

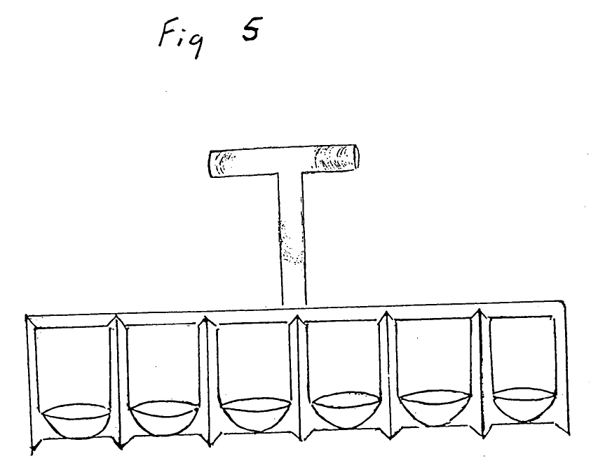

page 2 FIG. 4 is a view of the front of the feeder.

Page 2 FIG. 4 number 15 is the ball handle.

Page 2 FIG. 4 number 16 a view of the inner side wall partitions.

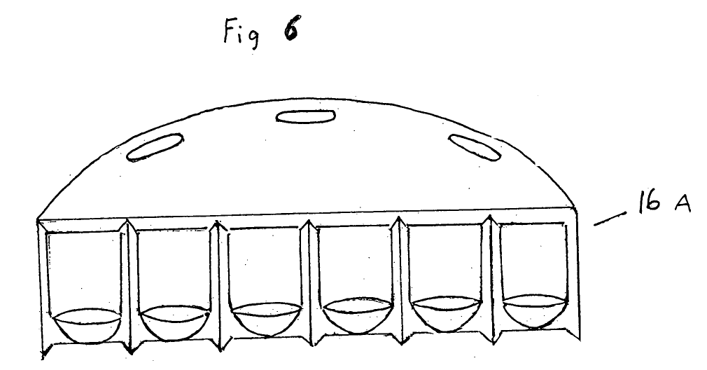

Page 3 FIG. 5 the back view of the feeder.

page 4 FIG. 6 the raised inner wall showing the port hole handles.

Page 4 FIG. 6 number 16a raised inner wall and extended partitions.

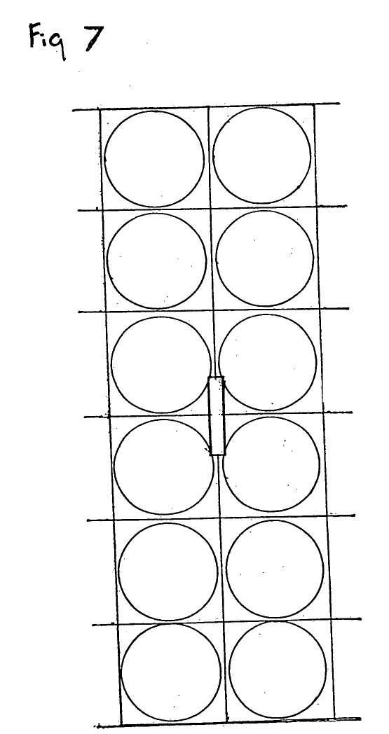

Page 5 FIG. 7 Overview of feeding bins and T handle and their placement.

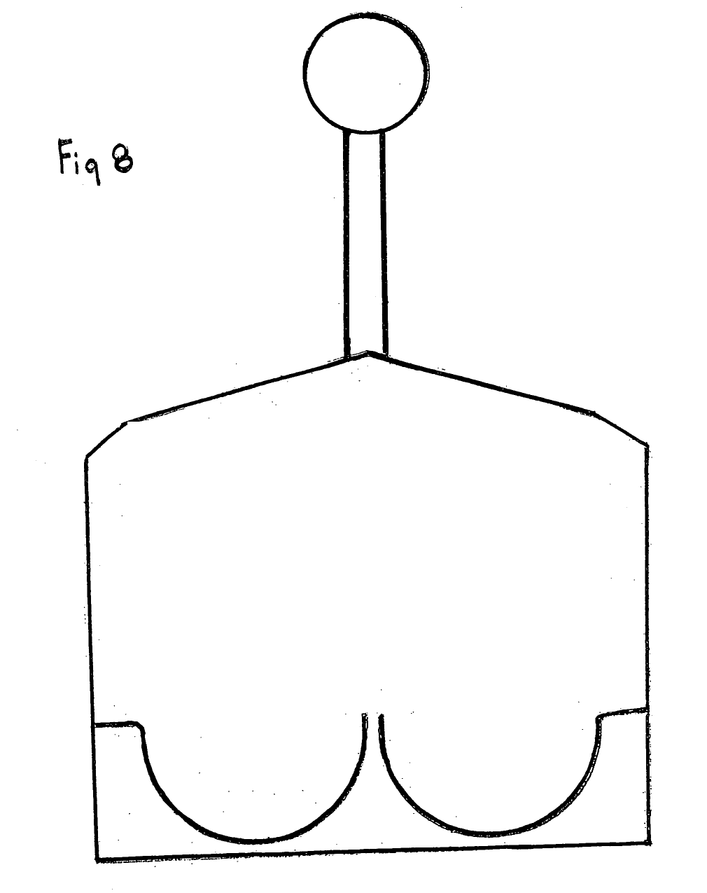

Page 6 FIG. 8 A transparent view of the ends of the feeder with molded bowls.

1. Unlike other pet feeders this comes with T shaped and a ball shaped handle which makes it easy to lift the feeder off the ground to place the food in the feeder. The T shaped and ball shaped handles are interchangeable. They screw in to the top of the feeder tray and in to the bottom that connects to a square plate with a mounted tube with threads. The shaft of the handle has an aluminum threaded flair at the bottom which tightens down through the feeder into the threaded tube and plate. The flair is made of aluminum. The plate supports the base of the feeder which adds support, weight, and balance.

2. This feeder has partitioned side walls with a one inch extention at the bottom of each partition. That creates more depth and isolation to each stall for separate feedings. A one inch long horizontal extention and a one and a half inch inner height bowl connection to side partitions which are five and a half inches high. Each stall is four inches wide and five inches deep.

3. The bottom of the food stalls are round in shape and curved for easy cleaning. It makes it easier for the pets to feed. This pet feeder has from four to sixteen feeding compartments.

4. There is also a raised center wall with port hole handles manufactured as one entire piece.
